(19) United States
(12) Patent Application Publication
(10) Pub. No.: US 2005/0235950 A1
(43) Pub. Date: Oct. 27, 2005

(54) Air and fuel supply system for combustion engine

(76) Inventors: James R. Weber, Lacon, IL (US); Scott A. Leman, Eureka, IL (US); Gerald N. Coleman, Bulwick (GB); Kevin P. Duffy, Metamora, IL (US); Eric C. Fluga, Dunlap, IL (US); Jonathan P. Kilkenny, Peoria, IL (US); Steven Y. Tien, Bloomington, IL (US)

Correspondence Address: CATERPILLAR INC.;100 N.E. ADAMS STREET, PATENT DEPT., PEORIA, IL, 616296490, US

(21) Appl. No.: 10/992,897

(22) Filed: Nov. 19, 2004

Related U.S. Application Data
(63) Continuation-in-part of application No. 10/733,570, filed on Dec. 12, 2003.
Application No. 10/733,570 is a continuation of application No. 10/143,908, filed on May 14, 2002, now Pat. No. 6,688,280.
(63) Continuation-in-part of application No. 10/933,300, filed on Sep. 3, 2004.
Application No. 10/933,300 is a continuation-in-part of application No. 10/733,570, filed on Dec. 12, 2003.
Application No. 10/733,570 is a continuation of application No. 10/143,908, filed on May 14, 2002, now Pat. No. 6,688,280.
(63) Continuation-in-part of application No. 10/600,877, filed on Jun. 20, 2003.
(60) Provisional application No. 60/413,403, filed on Sep. 25, 2002.

(51) Int. Cl. F02B 3/00; F01L 1/34; F02M 25/07; F02B 75/02

(52) U.S. Cl. 123/299; 123/316; 123/90.16; 123/568.14

(57) ABSTRACT

A method of operating an internal combustion engine including at least one cylinder and a piston slidable in the cylinder is provided. In at least one embodiment, the method includes: supplying a mixture of pressurized air and recirculated exhaust gas from an intake manifold to an air intake port of a combustion chamber in the cylinder; operating an air intake valve to open the air intake port to allow the pressurized air and exhaust gas mixture to flow between the combustion chamber and the intake manifold during a portion of a compression stroke of the piston; and operably controlling a fuel supply system to inject fuel into the combustion chamber via a common rail fuel injector.

This application is a continuation-in-part of application Ser. No. 10/733,570, filed Dec. 12, 2003, which is a continuation of application Ser. No. 10/143,908, filed May 14, 2002, now U.S. Pat. No. 6,688,280; this application is also a continuation-in-part of application Ser. No. 10/933,300, filed Sep. 3, 2004, which is a continuation-in-part of application Ser. No. 10/733,570, filed Dec. 12, 2003, which is a continuation of application Ser. No. 10/143,908, filed May 14, 2002, which is now U.S. Pat. No. 6,688,280; this application is also a continuation-in-part of application Ser. No. 10/600,877, filed Jun. 20, 2003, which claims the benefit of U.S. Provisional Application 60/413,403, filed Sep. 25, 2002; the content of all of the above are hereby incorporated by reference.

### TECHNICAL FIELD

The present description relates to a combustion engine and, more particularly, to an air and fuel supply system for use with an internal combustion engine, including the use of common rail fuel injectors for controlling the flow of high-pressure fuel to the combustion chamber of the engine.

### BACKGROUND

As emission requirements continue to become more stringent, engine manufacturers and component suppliers continue to improve engine operation. One area that has received particular focus has been fuel injection. By more accurately controlling fuel injection, improved combustion can be achieved, providing better engine efficiency and reduced emissions.

One type of fuel injector that has received much attention has been the common rail injector. The common rail fuel injector controls the injection of high-pressure fuel that the injector receives from a high-pressure fuel rail. The injector does not pressurize the fuel but simply controls injection by controlling the check valve. Typically, high-pressure fuel is constantly present in the tip of the fuel injector and injection occurs by actuating a control valve to vent a check control cavity, allowing the high-pressure fuel in the tip to push the check valve up.

Although the common rail injector provides good control of fuel injection, improvement is still necessary. Specifically, the common rail injector has limited rate-shaping capability, generally a square rate shape, due to the fact that high-pressure fuel is always present in the tip. Further, the common rail fuel injector's delivery curve is not linear and can have unusable ranges because fuel injection starts as soon as the control valve is actuated, as opposed to waiting until the control valve is seated.

Furthermore, leakage of high-pressure fuel-within the injector contributes to losses and less than optimal system efficiency, as such leakage requires the pump to pressurize such fuel, yet the system does not benefit from the fuel which leaks.

The constant presence of high-pressure fuel in the tip of such common rail injectors is also seen as a potential source of engine damage, should the nozzle needle remain in an open or partially-open position. One way to address this concern is changing the internal plumbing arrangement of the injector's valves and lines to form an admission valve. Such admission valves only allow high pressure fuel to be present in the tip only when injection is desired, rather these valves block the high pressure from reaching the tip during the non-injection period and vent any pressure remaining in the tip at the end of injection back to tank. Typical common rail injectors in production today utilize a 3-port, 2-position valve, and do not block the fuel from reaching the tip during the non-injection period.

Some admission valves are described as a control slide, or spool valves, whose control edges meter the fuel quantity to be delivered, and even attempt to limit leakage losses by closing the outlet side opening before opening the inlet side opening. Such spool valves must have diametral clearance to move, however, and such clearance forms a leakage path that contributes to losses.

An admission valve is shown in U.S. Pat. No. 5,538,187. This admission valve improves the control valve by forming a poppet valve rather than a spool valve. Such valves are known to seal better than spool valves, and therefore have lower leakage losses. The other end forms a flat valve seat, which are known to be difficult to achieve a tight seal, versus that possible with a poppet valve.

In addition to reducing emissions through controlled fuel injection, emissions may also be reduced by reducing the peak combustion temperatures within the main combustion chambers of the engine.

Oxides of nitrogen (“NOₓ”) form in an engine when nitrogen and oxygen, both of which are present in the air used for combustion, combine within the main combustion chambers. Typically, the level of NOₓ formed increases as the peak combustion temperatures within the combustion chambers increase. As such, minimizing the peak combustion temperatures within the main combustion chambers generally reduces the emission of NOₓ.

Early or late closing of the intake valve, referred to as the “Miller Cycle,” may reduce the effective compression ratio of the cylinder, which in turn reduces compression temperature and peak combustion temperatures, while maintaining a high expansion ratio. Consequently, a Miller cycle engine may have improved thermal efficiency and reduced exhaust emissions NOₓ. Reduced NOₓ emissions are desirable. In a conventional Miller cycle engine, the timing of the intake valve close is typically shifted slightly forward or backward from that of the typical Otto cycle engine. For example, in the Miller cycle engine, the intake valve may remain open until the beginning of the compression stroke.

Using either late or early intake valve closing, however, will often result in less air entering the combustion chamber. To compensate for this, the intake manifold pressure is boosted with a compressor, such as a turbocharger or supercharger.

A turbocharger typically includes a turbine driven by exhaust gases of the engine and a compressor driven by the turbine. The compressor receives the fluid to be compressed and supplies the compressed fluid to the combustion chambers. The fluid compressed by the compressor may be in the form of combustion air or an air/fuel mixture.

An internal combustion engine may also include a supercharger arranged in series with a turbocharger compressor of an engine. U.S. Pat. No. 6,273,076 (Beck et al., issued Aug. 14, 2001) discloses a supercharger having a turbine that drives a compressor to increase the pressure of air flowing to a turbocharger compressor of an engine. In some situations, the air charge temperature may be reduced below ambient air temperature by an early closing of the intake valve.

While a turbocharger may utilize some energy from the engine exhaust, the series supercharger/turbocharger arrangement does not utilize energy from the turbocharger exhaust. Furthermore, the supercharger requires an additional energy source, thus reducing the overall efficiency of the engine.

The present description is directed to overcoming one or more of the problems as set forth above.

### SUMMARY

According to one aspect, a method of operating an internal combustion engine including least one cylinder and a piston slidable in the cylinder. The method comprises supplying pressurized air an intake manifold to an air intake port of a combustion chamber in the cylinder, operating an air intake valve to open the air intake port to allow the pressurized air and exhaust gas mixture to flow between the combustion chamber and the intake manifold during a portion of a compression stroke of the piston, and operably controlling a fuel supply system to inject fuel into the combustion chamber via a common rail fuel injector.

In at least some of the embodiments, the pressurized air includes a mixture of pressurized air and recirculated exhaust gas.

It is to be understood that both the foregoing general description and the following detailed description are and explanatory only and are not restrictive.

### BRIEF DESCRIPTION OF THE DRAWINGS

The accompanying drawings, which are incorporated in and constitute a part of this specification, illustrate several embodiments and, together with the description, serve to explain the principles. In the drawings,

FIG. 1 is a combination diagrammatic and schematic illustration of an air supply system for an internal combustion engine in accordance with the description;

FIG. 2 is a combination diagrammatic and schematic illustration of an engine cylinder in accordance with the description;

FIG. 3 is a graph illustrating an intake valve actuation as a function of engine crank angle in accordance with the present description;

FIG. 4 is a graph illustrating an fuel injection as a function of engine crank angle in accordance with the present description;

FIG. 5 is a combination diagrammatic and schematic illustration of another air supply system for an internal combustion engine in accordance with the description;

FIG. 6 is a combination diagrammatic and schematic illustration of yet another air supply system for an internal combustion engine in accordance with the description;

FIG. 7 is a combination diagrammatic and schematic illustration of an exhaust gas recirculation system included as part of an internal combustion engine in accordance with the description;

FIG. 8 is a diagrammatic schematic of a fuel system using a common rail fuel injector;

FIG. 9 is a diagrammatic cross section of a fuel injector according to one embodiment of the present description;

FIG. 10 is a diagrammatic cross section of a fuel injector according to one embodiment of the present description;

FIG. 11 is a diagrammatic cross section of a fuel injector according to still another embodiment of the present description;

FIG. 12 is a diagrammatic schematic of a fuel injector according to one embodiment of the present description; and

FIG. 13 is an example of a fuel delivery curve.

### DETAILED DESCRIPTION

Reference will now be made in detail to embodiments of the description, examples of which are illustrated in the accompanying drawings. Wherever possible, the same reference numbers will be used throughout the drawings to refer to the same or like parts.

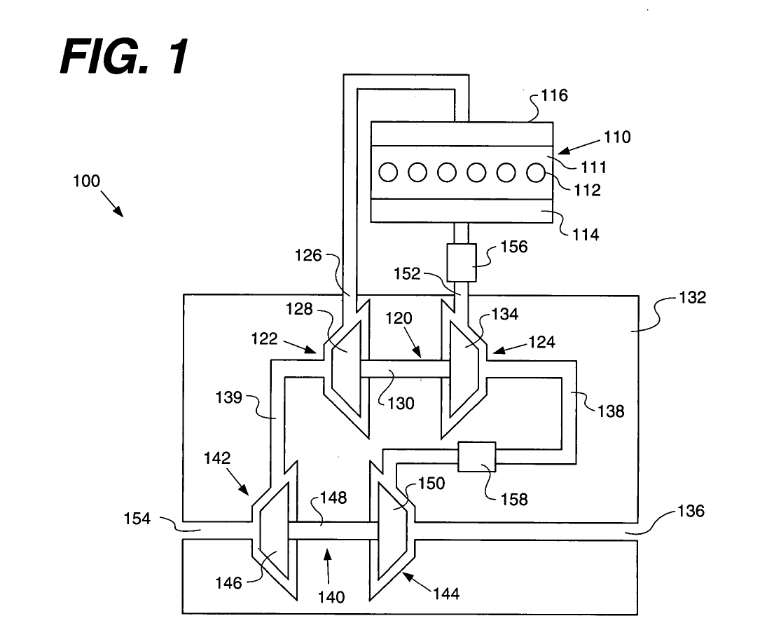

Referring to FIG. 1, an air supply system 100 for an internal combustion engine 110, for example, a four-stroke, diesel engine, is provided. The internal combustion engine 110 includes an engine block 111 defining a plurality of combustion cylinders 112, the number of which depends upon the particular application. For example, a 4-cylinder engine would include four combustion cylinders, a 6-cylinder engine would include six combustion cylinders, etc. In the embodiment of FIG. 1, six combustion cylinders 112 are shown. It should be appreciated that the engine 110 may be any other type of internal combustion engine, for example, a gasoline or natural gas engine.

The internal combustion engine 110 also includes an intake manifold 114 and an exhaust manifold 116. The intake manifold 114 provides fluid, for example, air or a fuel/air mixture, to the combustion cylinders 112. The exhaust manifold 116 receives exhaust fluid, for example, exhaust gas, from the combustion cylinders 112. The intake manifold 114 and the exhaust manifold 116 are shown as a single-part construction for simplicity in the drawing. However, it should be appreciated that the intake manifold 114 and/or the exhaust manifold 116 may be constructed as multi-part manifolds, depending upon the particular application.

The air supply system 100 includes a first turbocharger 120 and may include a second turbocharger 140. The first and second turbochargers 120, 140 may be arranged in series with one another such that the second turbocharger 140 provides a first stage of pressurization and the first turbocharger 120 provides a second stage of pressurization. For example, the second turbocharger 140 may be a low pressure turbocharger and the first turbocharger 120 may be a high pressure turbocharger. The first turbocharger 120 includes a turbine 122 and a compressor 124. The turbine 122 is fluidly connected to the exhaust manifold 116 via an exhaust duct 126. The turbine 122 includes a turbine wheel 128 carried by a shaft 130, which in turn may be rotatably carried by a housing 132, for example, a single-part or multi-part housing. The fluid flow path from the exhaust manifold 116 to the turbine 122 may include a variable nozzle (not shown) or other variable geometry arrangement adapted to control the velocity of exhaust fluid impinging on the turbine wheel 128.

The compressor 124 includes a compressor wheel 134 carried by the shaft 130. Thus, rotation of the shaft 130 by the turbine wheel 128 in turn may cause rotation of the compressor wheel 134.

The first turbocharger 120 may include a compressed air duct 138 for receiving compressed air from the second turbocharger 140 and an air outlet line 152 for receiving compressed air from the compressor 124 and supplying the compressed air to the intake manifold 114 of the engine 110. The first turbocharger 120 may also include an exhaust duct 139 for receiving exhaust fluid from the turbine 122 and supplying the exhaust fluid to the second turbocharger 140.

The second turbocharger 140 may include a turbine 142 and a compressor 144. The turbine 142 may be fluidly connected to the exhaust duct 139. The turbine 142 may include a turbine wheel 146 carried by a shaft 148, which in turn may be rotatably carried by the housing 132. The compressor 144 may include a compressor wheel 150 carried by the shaft 148. Thus, rotation of the shaft 148 by the turbine wheel 146 may in turn cause rotation of the compressor wheel 150.

The second turbocharger 140 may include an air intake line 136 providing fluid communication between the atmosphere and the compressor 144. The second turbocharger 140 may also supply compressed air to the first turbocharger 120 via the compressed air duct 138. The second turbocharger 140 may include an exhaust outlet 154 for receiving exhaust fluid from the turbine 142 and providing fluid communication with the atmosphere. In an embodiment, the first turbocharger 120 and second turbocharger 140 may be sized to provide substantially similar compression ratios. For example, the first turbocharger 120 and second turbocharger 140 may both provide compression ratios of between 2 to 1 and 3 to 1, resulting in a system compression ratio of at least 4:1 with respect to atmospheric pressure. Alternatively, the second turbocharger 140 may provide a compression ratio of 3 to 1 and the first turbocharger 120 may provide a compression ratio of 1.5 to 1, resulting in a system compression ratio of 4.5 to 1 with respect to atmospheric pressure.

The air supply system 100 may include an air cooler 156, for example, an aftercooler, between the compressor 124 and the intake manifold 114. The air cooler 156 may extract heat from the air to lower the intake manifold temperature and increase the air density. Optionally, the air supply system 100 may include an additional air cooler 158, for example, an intercooler, between the compressor 144 of the second turbocharger 140 and the compressor 124 of the first turbocharger 120. Intercooling may use techniques such as jacket water, air to air, and the like. Alternatively, the air supply system 100 may optionally include an additional air cooler (not shown) between the air cooler 156 and the intake manifold 114. The optional additional air cooler may further reduce the intake manifold temperature. A jacket water pre-cooler (not shown) may be used to protect the air cooler 156.

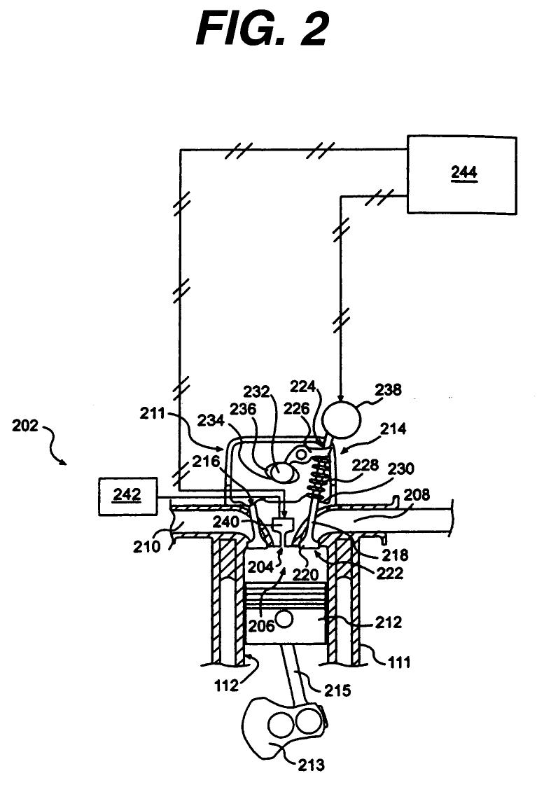

Referring now to FIG. 2, a cylinder head 211 may be connected with the engine block 111. Each cylinder 112 in the cylinder head 211 may be provided with a fuel supply system 202. The fuel supply system 202 may include a fuel port 204 opening to a combustion chamber 206 within the cylinder 112. The fuel supply system 202 may inject fuel, for example, diesel fuel, directly into the combustion chamber 206.

The cylinder 112 may contain a piston 212 slidably movable in the cylinder. A crankshaft 213 may be rotatably disposed within the engine block 111. A connecting rod 215 may couple the piston 212 to the crankshaft 213 so that sliding motion of the piston 212 within the cylinder 112 results in rotation of the crankshaft 213. Similarly, rotation of the crankshaft 213 results in a sliding motion of the piston 212. For example, an uppermost position of the piston 212 in the cylinder 112 corresponds to a top dead center position of the crankshaft 213, and a lowermost position of the piston 212 in the cylinder 112 corresponds to a bottom dead center position of the crankshaft 213.

As one skilled in the art will recognize, the piston 212 in a conventional, four-stroke engine cycle reciprocates between the uppermost position and the lowermost position during a combustion (or expansion) stroke, an exhaust stroke, and intake stroke, and a compression stroke. Meanwhile, the crankshaft 213 rotates from the top dead center position to the bottom dead center position during the combustion stroke, from the bottom dead center to the top dead center during the exhaust stroke, from top dead center to bottom dead center during the intake stroke, and from bottom dead center to top dead center during the compression stroke. Then, the four-stroke cycle begins again. Each piston stroke correlates to about 180° of crankshaft rotation, or crank angle. Thus, the combustion stroke may begin at about 0° crank angle, the exhaust stroke at about 180°, the intake stroke at about 360°, and the compression stroke at about 540°.

The cylinder 112 may include at least one intake port 208 and at least one exhaust port 210, each opening to the combustion chamber 206. The intake port 208 may be opened and closed by an intake valve assembly 214, and the exhaust port 210 may be opened and closed by an exhaust valve assembly 216. The intake valve assembly 214 may include, for example, an intake valve 218 having a head 220 at a first end 222, with the head 220 being sized and arranged to selectively close the intake port 208. The second end 224 of the intake valve 218 may be connected to a rocker arm 226 or any other conventional valve-actuating mechanism. The intake valve 218 may be movable between a first position permitting flow from the intake manifold 114 to enter the combustion cylinder 112 and a second position substantially blocking flow from the intake manifold 114 to the combustion cylinder 112. A spring 228 may be disposed about the intake valve 218 to bias the intake valve 218 to the second, closed position.

A camshaft 232 carrying a cam 234 with one or more lobes 236 may be arranged to operate the intake valve assembly 214 cyclically based on the configuration of the cam 234, the lobes 236, and the rotation of the camshaft 232 to achieve a desired intake valve timing. The exhaust valve assembly 216 may be configured in a manner similar to the intake valve assembly 214 and may be operated by one of the lobes 236 of the cam 234. In an embodiment, the intake lobe 236 may be configured to operate the intake valve 218 in a conventional Otto or diesel cycle, whereby the intake valve 218 moves to the second position from between about 10° before bottom dead center of the intake stroke and about 10° after bottom dead center of the compression stroke. Alternatively, the intake valve assembly 214 and/or the exhaust valve assembly 216 may be operated hydraulically, pneumatically, electronically, or by any combination of mechanics, hydraulics, pneumatics, and/or electronics.

The intake valve assembly 214 may include a variable intake valve closing mechanism 238 structured and arranged to selectively interrupt cyclical movement of and extend the closing timing of the intake valve 218. The variable intake valve closing mechanism 238 may be operated hydraulically, pneumatically, electronically, mechanically, or any combination thereof. For example, the variable intake valve closing mechanism 238 may be selectively operated to supply hydraulic fluid, for example, at a low pressure or a high pressure, in a manner to resist closing of the intake valve 218 by the bias of the spring 228. That is, after the intake valve 218 is lifted, i.e., opened, by the cam 234, and when the cam 234 is no longer holding the intake valve 218 open, the hydraulic fluid may hold the intake valve 218 open for a desired period. The desired period may change depending on the desired performance of the engine 110. Thus, the variable intake valve closing mechanism 238 enables the engine 110 to operate under a conventional Otto or diesel cycle or under a variable late-closing Miller cycle.

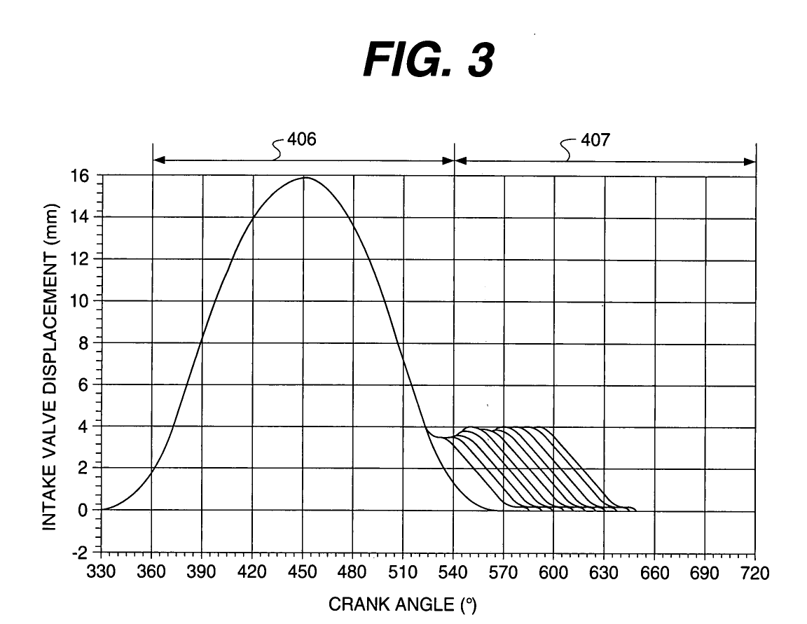

As shown in FIG. 3, the intake valve 218 may begin to open at about 360° crank angle, that is, when the crankshaft 213 is at or near a top dead center position of an intake stroke 406. The closing of the intake valve 218 may be selectively varied from about 540° crank angle, that is, when the crank shaft is at or near a bottom dead center position of a compression stroke 407, to about 650° crank angle, that is, about 70° before top center of the combustion stroke 508. Thus, the intake valve 218 may be held open for a majority portion of the compression stroke 407, that is, for the first half of the compression stroke 407 and a portion of the second half of the compression stroke 407.

The fuel supply system 202 may include a fuel injector assembly 240, for example, a mechanically-actuated, electronically-controlled unit injector, in fluid communication with a common fuel rail 242. Alternatively, the fuel injector assembly 240 may be any common rail type injector and may be actuated and/or operated hydraulically, mechanically, electrically, piezo-electrically, or any combination thereof. The common fuel rail 242 provides fuel to the fuel injector assembly 240 associated with each cylinder 112. The fuel injector assembly 240 may inject or otherwise spray fuel into the cylinder 112 via the fuel port 204 in accordance with a desired timing.

A controller 244 may be electrically connected to the variable intake valve closing mechanism 238 and/or the fuel injector assembly 240. The controller 244 may be configured to control operation of the variable intake valve closing mechanism 238 and/or the fuel injector assembly 240 based on one or more engine conditions, for example, engine speed, load, pressure, and/or temperature in order to achieve a desired engine performance. It should be appreciated that the functions of the controller 244 may be performed by a single controller or by a plurality of controllers. Similarly, spark timing in a natural gas engine may provide a similar function to fuel injector timing of a compression ignition engine.

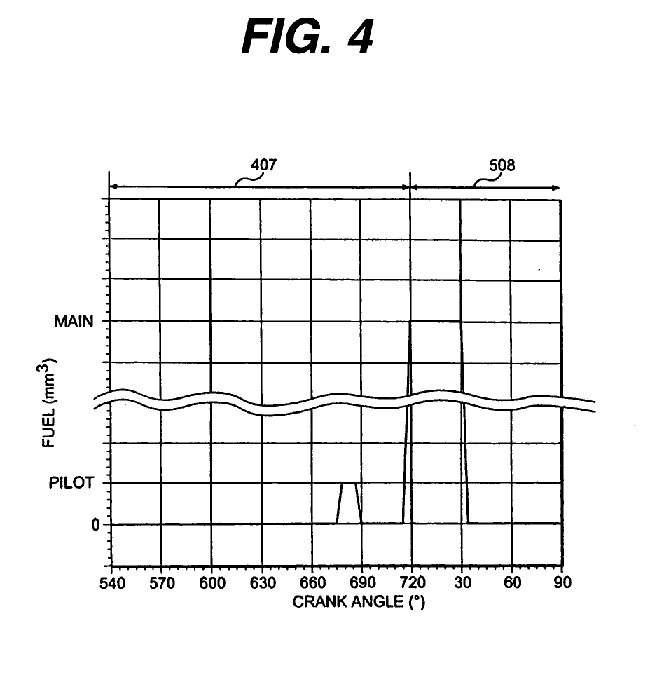

As shown in the graph of FIG. 4, the pilot injection of fuel may commence when the crankshaft 213 is at about 675° crank angle, that is, about 45° before top dead center of the compression stroke 407. The main injection of fuel may occur when the crankshaft 213 is at about 710° crank angle, that is, about 10° before top dead center of the compression stroke 407 and about 45° after commencement of the pilot injection. Generally, the pilot injection may commence when the crankshaft 213 is about 40-50° before top dead center of the compression stroke 407 and may last for about 10-15° crankshaft rotation. The main injection may commence when the crankshaft 213 is between about 10° before top dead center of the compression stroke 407 and about 12° after top dead center of the combustion stroke 508. The main injection may last for about 20-45° crankshaft rotation. The pilot injection may use a desired portion of the total fuel used, for example about 10%.

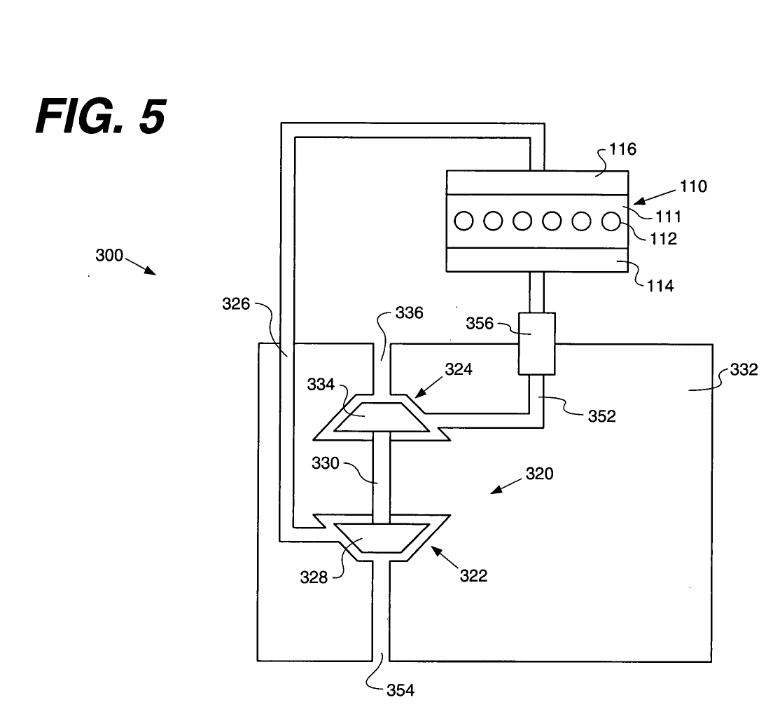

FIG. 5 is a combination diagrammatic and schematic illustration of a second air supply system 300 for the internal combustion engine 110. The air supply system 300 may include a turbocharger 320, for example, a high-efficiency turbocharger capable of producing at least about a 4 to 1 compression ratio with respect to atmospheric pressure. The turbocharger 320 may include a turbine 322 and a compressor 324. The turbine 322 may be fluidly connected to the exhaust manifold 116 via an exhaust duct 326. The turbine 322 may include a turbine wheel 328 carried by a shaft 330, which in turn may be rotatably carried by a housing 332, for example, a single-part or multi-part housing. The fluid flow path from the exhaust manifold 116 to the turbine 322 may include a variable nozzle (not shown), which may control the velocity of exhaust fluid impinging on the turbine wheel 328.

The compressor 324 may include a compressor wheel 334 carried by the shaft 330. Thus, rotation of the shaft 330 by the turbine wheel 328 in turn may cause rotation of the compressor wheel 334. The turbocharger 320 may include an air inlet 336 providing fluid communication between the atmosphere and the compressor 324 and an air outlet 352 for supplying compressed air to the intake manifold 114 of the engine 110. The turbocharger 320 may also include an exhaust outlet 354 for receiving exhaust fluid from the turbine 322 and providing fluid communication with the atmosphere.

The air supply system 300 may include an air cooler 356 between the compressor 324 and the intake manifold 114. Optionally, the air supply system 300 may include an additional air cooler (not shown) between the air cooler 356 and the intake manifold 114.

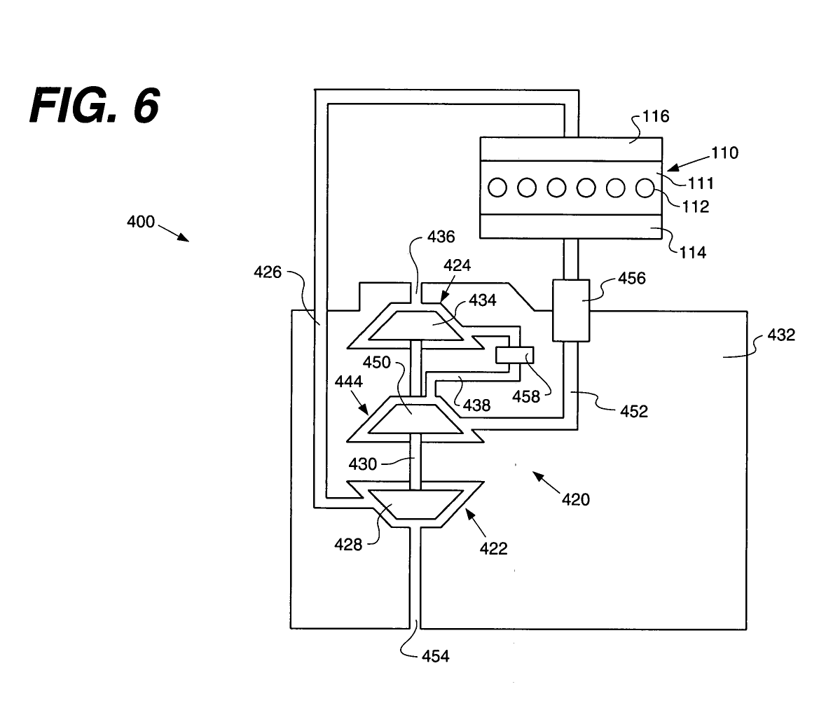

FIG. 6 is a combination diagrammatic and schematic illustration of a third air supply system 400 for the internal combustion engine 110. The air supply system 400 may include a turbocharger 420, for example, a turbocharger 420 having a turbine 422 and two compressors 424, 444. The turbine 422 may be fluidly connected to the exhaust manifold 116 via an inlet duct 426. The turbine 422 may include a turbine wheel 428 carried by a shaft 430, which in turn may be rotatably carried by a housing 432, for example, a single-part or multi-part housing. The fluid flow path from the exhaust manifold 116 to the turbine 422 may include a variable nozzle (not shown), which may control the velocity of exhaust fluid impinging on the turbine wheel 428.

The first compressor 424 may include a compressor wheel 434 carried by the shaft 430, and the second compressor 444 may include a compressor wheel 450 carried by the shaft 430. Thus, rotation of the shaft 430 by the turbine wheel 428 in turn may cause rotation of the first and second compressor wheels 434, 450. The first and second compressors 424, 444 may provide first and second stages of pressurization, respectively.

The turbocharger 420 may include an air intake line 436 providing fluid communication between the atmosphere and the first compressor 424 and a compressed air duct 438 for receiving compressed air from the first compressor 424 and supplying the compressed air to the second compressor 444. The turbocharger 420 may include an air outlet line 452 for supplying compressed air from the second compressor 444 to the intake manifold 114 of the engine 110. The turbocharger 420 may also include an exhaust outlet 454 for receiving exhaust fluid from the turbine 422 and providing fluid communication with the atmosphere.

For example, the first compressor 424 and second compressor 444 may both provide compression ratios of between 2 to 1 and 3 to 1, resulting in a system compression ratio of at least 4:1 with respect to atmospheric pressure. Alternatively, the second compressor 444 may provide a compression ratio of 3 to 1 and the first compressor 424 may provide a compression ratio of 1.5 to 1, resulting in a system compression ratio of 4.5 to 1 with respect to atmospheric pressure.

The air supply system 400 may include an air cooler 456 between the compressor 424 and the intake manifold 114. Optionally, the air supply system 400 may include an additional air cooler 458 between the first compressor 424 and the second compressor 444 of the turbocharger 420. Alternatively, the air supply system 400 may optionally include an additional air cooler (not shown) between the air cooler 456 and the intake manifold 114.

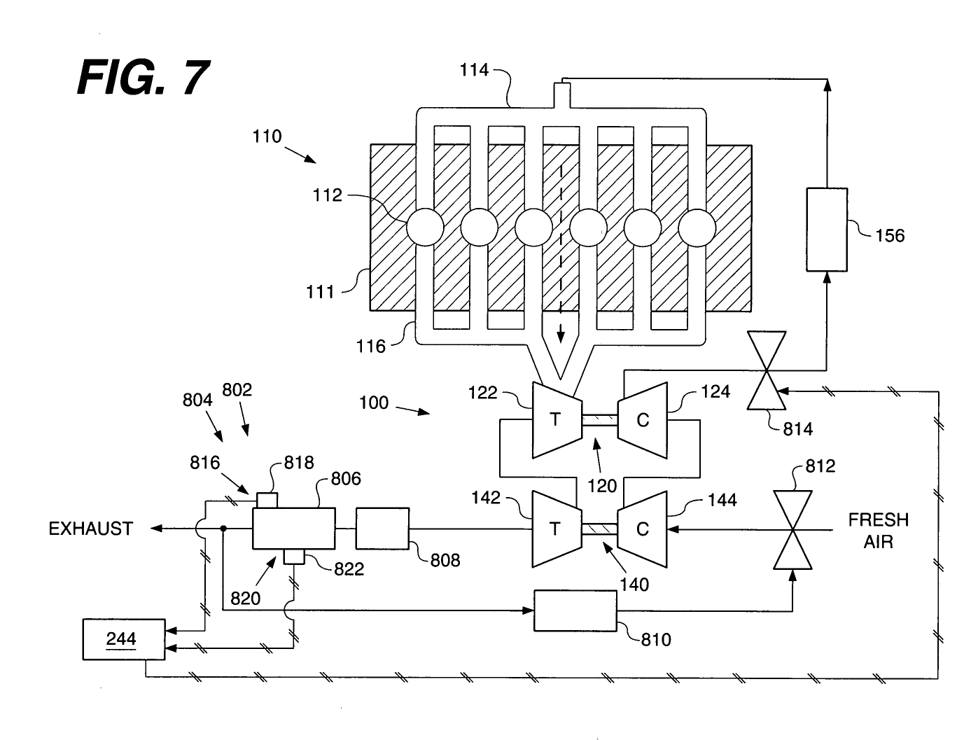

Referring to FIG. 7, an exhaust gas recirculation (“EGR”) system 804 in an exhaust system 802 in a combustion engine 110 is shown. Combustion engine 110 includes intake manifold 114 and exhaust manifold 116. Engine block 111 provides housing for at least one cylinder 112. FIG. 7 depicts six cylinders 112. However, any number of cylinders 112 could be used, for example, three, six, eight, ten, twelve, or any other number. The intake manifold 114 provides an intake path for each cylinder 112 for air, recirculated exhaust gases, or a combination thereof. The exhaust manifold 116 provides an exhaust path for each cylinder 112 for exhaust gases.

In the embodiment shown in FIG. 7, the air supply system 100 is shown as a two-stage turbocharger system. Air supply system 100 includes first turbocharger 120 having turbine 122 and compressor 124. Air supply system 100 also includes second turbocharger 140 having turbine 142 and compressor 144. The two-stage turbocharger system operates to increase the pressure of the air and exhaust gases being delivered to the cylinders 112 via intake manifold 114, and to maintain a desired air to fuel ratio during extended open durations of intake valves. It is noted that a two-stage turbocharger system is not required for operation. Other types of turbocharger systems, such as a high pressure ratio single-stage turbocharger system, a variable geometry turbocharger system, and the like, may be used instead.

A throttle valve 814, located between compressor 124 and intake manifold 114, may be used to control the amount of air and recirculated exhaust gases being delivered to the cylinders 112. The throttle valve 814 is shown between compressor 124 and an aftercooler 156. However, the throttle valve 814 may be positioned at other locations, such as after aftercooler 156. Operation of the throttle valve 814 is described in more detail below.

The EGR system 804 shown in FIG. 7 is typical of a low pressure EGR system in an internal combustion engine. Variations of the EGR system 804 may be equally used, including both low pressure loop and high pressure loop EGR systems. Other types of EGR systems, such as for example by-pass, venturi, piston-pumped, peak clipping, and back pressure, could be used.

An oxidation catalyst 808 receives exhaust gases from turbine 142, and serves to reduce HC emissions. The oxidation catalyst 808 may also be coupled with a De-NOₓ catalyst to further reduce NOₓ emissions. A particulate Although oxidation catalyst 808 and PM filter 806 are shown as separate items, they may alternatively be combined into one package.

Some of the exhaust gases are delivered out the exhaust from the PM filter 806. However, a portion of exhaust gases are rerouted to the intake manifold 114 through an EGR cooler 810, through an EGR valve 812, and through first and second turbochargers 120,140. EGR cooler 810 may be of a type well known in the art, for example a jacket water or an air to gas heat exchanger type.

A means 816 for determining pressure within the PM filter 806 is shown. In the preferred embodiment, the means 816 for determining pressure includes a pressure sensor 818. However, other alternate means 816 may be employed. For example, the pressure of the exhaust gases in the PM filter 806 may be estimated from a model based on one or more parameters associated with the engine 110. Parameters may include, but are not limited to, engine load, engine speed, temperature, fuel usage, and the like.

A means 820 for determining flow of exhaust gases through the PM filter 806 may be used. Preferably, the means 820 for determining flow of exhaust gases includes a flow sensor 822. The flow sensor 822 may be used alone to determine pressure in the PM filter 806 based on changes in flow of exhaust gases, or may be used in conjunction with the pressure sensor 818 to provide more accurate pressure change determinations.

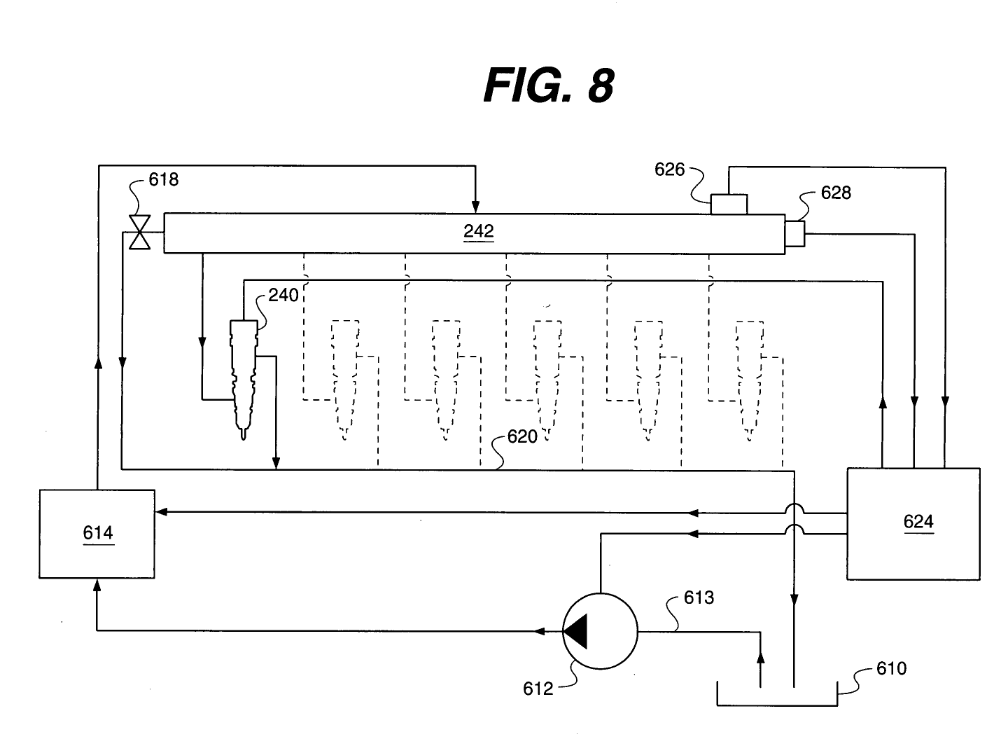

Referring to FIG. 8, a fuel system utilizing a common rail fuel injector 240 is shown. A reservoir 610 contains fuel at a ambient pressure. A transfer pump 612 draws low-pressure fuel through fuel supply line 613 and provides it to high-pressure pump 614. High-pressure pump 614 then pressurizes the fuel to desired fuel injection pressure levels and delivers the fuel to fuel rail 242. The pressure in fuel rail 242 is controlled in part by safety valve 618, which spills fuel to the fuel return line 620 if the pressure in rail 242 is above a desired pressure. The fuel return line 620 returns fuel to low-pressure reservoir 610.

Fuel injector 240 draws fuel from rail 242 and injects it into a combustion cylinder of the engine (not shown). Fuel not injected by injector 240 is spilled to fuel-return line 620. Electronic Control Module (“ECM”) 624 provides general control for the system. ECM 624 receives various input signals, such as from pressure sensor 626 and a temperature sensor 628 connected to fuel rail 242, to determine operational conditions. ECM 624 then sends out various control signals to various components including the transfer pump 612, high-pressure pump 614, and fuel injector 240.

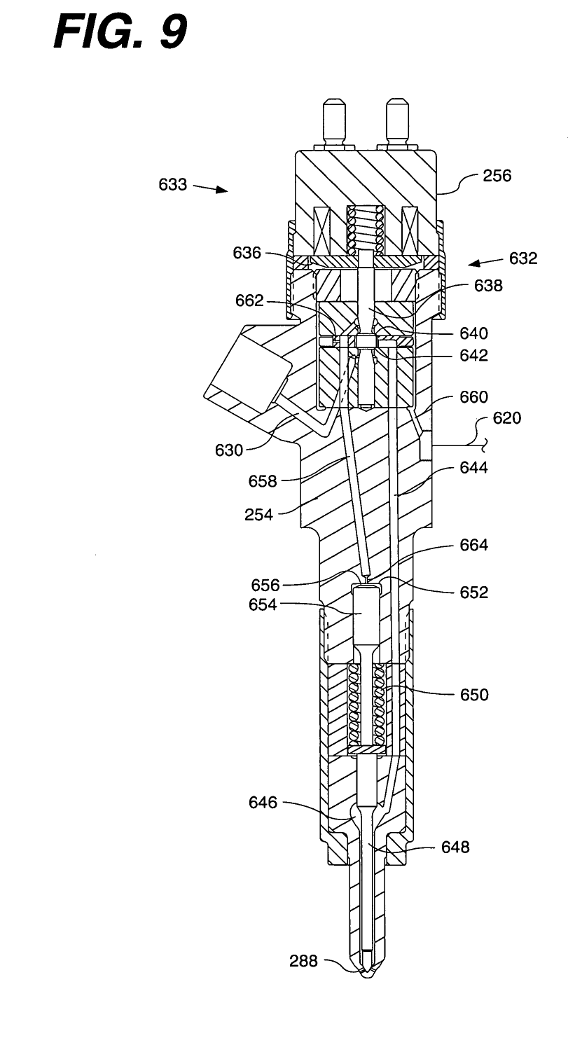

Reference is now made to FIGS. 9 thru 12. High-pressure fuel enters the injector through high-pressure fuel supply 630 and travels to control valve 632. Control valve 632 includes an electrical actuator, such as a piezo or a solenoid (as illustrated in FIGS. 9 through 11). Valve member 638 is movable in response to electrical actuator movement. Solenoid 256 controls the position of armature 636, which is attached to valve member 638. Valve member 638 moves between upper seat 640 and lower seat 642 to control the flow of fuel from the high-pressure fuel line 630 to check line 644. Although control valve 632 is shown as a poppet valve, other valve types, including spool valves, or combinations of various types of valves, etc, could be used.

High-pressure fuel in check line 644 travels through body 254 to fuel cavity 646 where it acts upon check 648 to push it in an upward direction against the biasing of check spring 650. When check 648 moves upwards, fuel exits injector 240 through at least one tip orifice 288.

The opening and closing of check 648 is controlled in part by the presence of high-pressure fuel in check line 644 and by the valve opening pressure created by check spring 650. Additionally, a check control cavity 652 exists on top of the check, and specifically on top of check piston 654, to control the opening of check valve 648. When the top surface 656 of check piston 654 is exposed to pressure in check control cavity 652, a force is exerted on check valve 648 biasing it in a closed position. The area of the top surface 656 exposed to fluid pressure from check control cavity 652 is generally larger than the area of check valve 648 exposed to fluid pressure in fuel cavity 646, thereby biasing check valve 648 in the closed position. It should be noted that various check designs are possible. A single piece check could be used or a multiple piece check could be used. Further, a check piston 654, as illustrated in FIGS. 9 thru 11 could be implemented. The key is having the check control cavity 652 provide a pressure force to bias check valve 648 in the closed position.

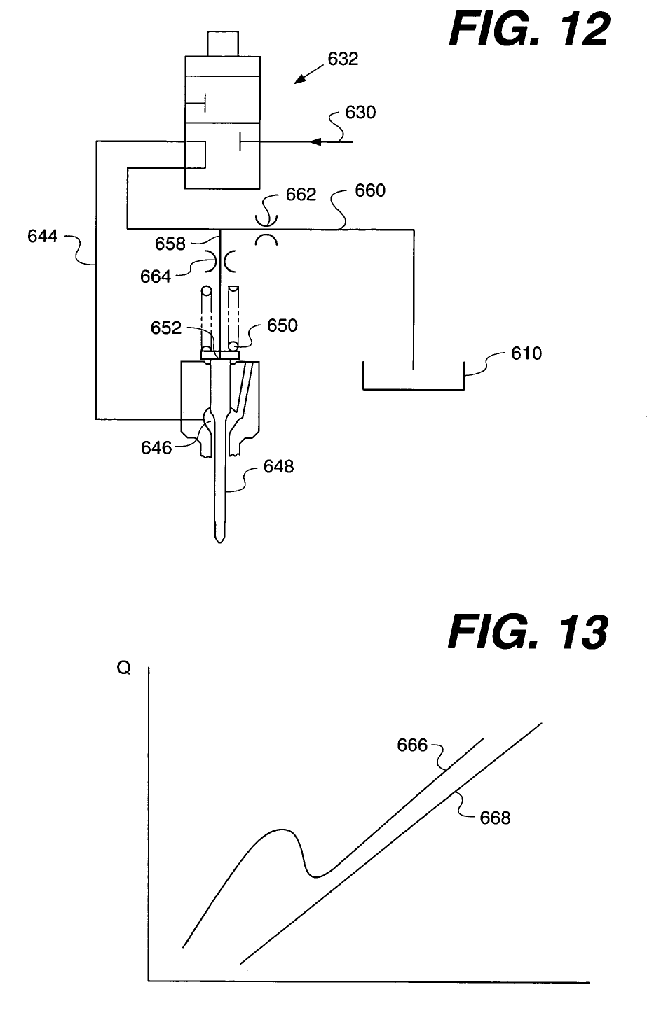

Pressurized fluid is provided to the check control cavity 652 through check control cavity line 658. Check control cavity 652 is always fluidly connected to low-pressure drain line 660. An orifice 662 in low-pressure drain line 660 provides a flow restriction causing flow to “back up” into check control cavity line 658, thereby pressurizing check control cavity 652 when a pressurized flow is present. A second orifice 664 can be provided in the check control cavity line 658 to regulate the flow of fluid into check control cavity 652. However, it should be noted that orifice 662 and second orifice 664 must be sized appropriately to achieve the desired flow; for example, if orifice 662 was too large compared to second orifice 664, flow would not “back up” and instead drain out just low-pressure drain line 660 to reservoir 610. Focusing particularly on control valve 632, the actuation of control valve 632 controls when injector 240 will inject. Specifically, control valve 632 controls the flow of high-pressure fuel from high-pressure fuel supply line 630 to check line 644. Further, it controls the venting of check line 644 and fuel cavity 646 when injection is over allowing check spring 650 to push check valve 648 closed. Furthermore, when control valve 632 stops injection it connects check line 644 to check control cavity line 658 and the low-pressure drain line 660. By doing so, the high-pressure fluid in check line 644 vents through control valve 632 to check control cavity 652 helping apply pressure on top of a check to ensure quicker closing. Additionally, when control valve 632 is transitioning between the open and closed position, such that the valve member 638 is between the upper seat 640 and the lower seat 642, high-pressure fuel supply line 630 actually provides high-pressure flow to both check line 644 and to check control cavity line 658. This results in high-pressure fuel being present in the both the fuel cavity 646 and the check control cavity 652. By pressurizing both ends of the check, the sum of the pressure forces and spring force is in the downward direction to hold the check in the closed position until the valve member 638 reaches the upper seat 640, which then places the injector into injection mode. (Note the control valve 632 in FIG. 12 does not illustrate the function of the valve while it is transitioning from one position to another as described in detail above).

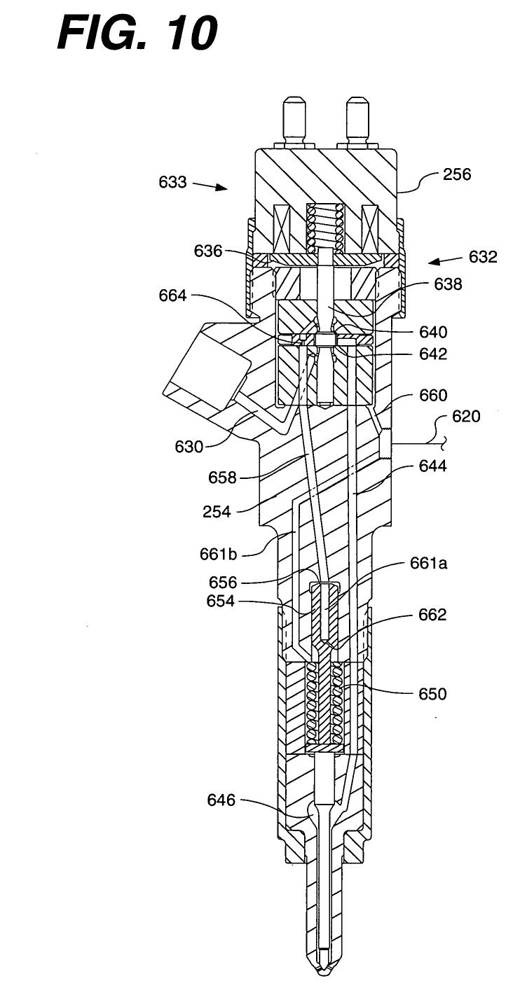

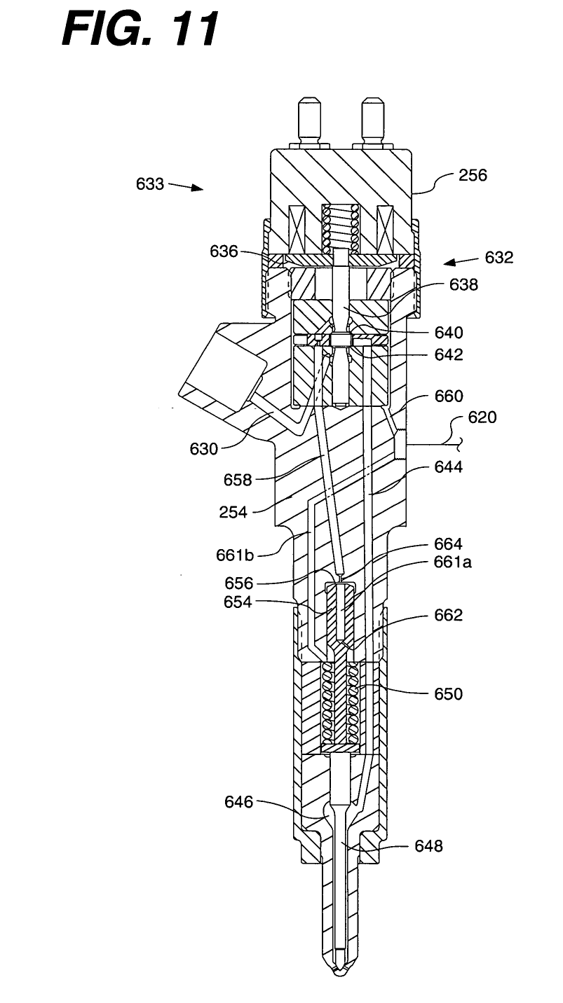

Referring to FIGS. 10 and 11, other embodiments are shown where the low-pressure drain line 660 has been moved from the control valve to the check piston 654 and body 254. In contrast to FIG. 9, the low-pressure drain line is shown as two segments 661a and 661b, where low-pressure drain line segment A 661a is a passage in the check piston 654, and low-pressure drain line segment B 661b is a passage in the body 254. The orifice 662 is also located in the check piston 654, fluidly connected to low-pressure drain line segment A. In FIG. 11 second orifice 664 remains in the body 254, but as shown in FIG. 10 could also be located in the control valve 632.

### INDUSTRIAL APPLICABILITY

During use, the internal combustion engine 110 operates in a known manner using, for example, the diesel principle of operation. Referring to the air supply system shown in FIG. 1, exhaust gas from the internal combustion engine 110 is transported from the exhaust manifold 116 through the inlet duct 126 and impinges on and causes rotation of the turbine wheel 128. The turbine wheel 128 is coupled with the shaft 130, which in turn carries the compressor wheel 134. The rotational speed of the compressor wheel 134 thus corresponds to the rotational speed of the shaft 130.

The fuel supply system 200 and cylinder 112 shown in FIG. 2 may be used with each of the air supply systems 100, 300, 400. Compressed air is supplied to the combustion chamber 206 via the intake port 208, and exhaust air exits the combustion chamber 206 via the exhaust port 210. The intake valve assembly 214 and the exhaust valve assembly 216 may be operated to direct airflow into and out of the combustion chamber 206.

In a conventional Otto or diesel cycle mode, the intake valve 218 moves from the second position to the first position in a cyclical fashion to allow compressed air to enter the combustion chamber 206 of the cylinder 112 at near top center of the intake stroke 406 (about 360° crank angle), as shown in FIG. 3. At near bottom dead center of the compression stroke (about 540° crank angle), the intake valve 218 moves from the first position to the second position to block additional air from entering the combustion chamber 206. Fuel may then be injector from the fuel injector assembly 240 at near top dead center of the compression stroke (about 720° crank angle).

In a conventional Miller cycle engine, the conventional Otto or diesel cycle is modified by moving the intake valve 218 from the first position to the second position at either some predetermined time before bottom dead center of the intake stroke 406 (i.e., before 540° crank angle) or some predetermined time after bottom dead center of the compression stroke 407 (i.e., after 540° crank angle). In a conventional late-closing Miller cycle, the intake valve 218 is moved from the first position to the second position during a first portion of the first half of the compression stroke 407.

The variable intake valve closing mechanism 238 enables the engine 110 to be operated in both a late-closing Miller cycle and a conventional Otto or diesel cycle. Further, injecting a substantial portion of fuel after top dead center of the combustion stroke 508, as shown in FIG. 4, may reduce NOₓ emissions and increase the amount of energy rejected to the exhaust manifold 116 in the form of exhaust fluid. Use of a high-efficiency turbocharger 320, 420 or series turbochargers 120, 140 may enable recapture of at least a portion of the rejected energy from the exhaust. The rejected energy may be converted into increased air pressures delivered to the intake manifold 114, which may increase the energy pushing the piston 212 against the crankshaft 213 to produce useable work. In addition, delaying movement of the intake valve 218 from the first position to the second position may reduce the compression temperature in the combustion chamber 206. The reduced compression temperature may further reduce NOₓ emissions.

The controller 244 may operate the variable intake valve closing mechanism 238 to vary the timing of the intake valve assembly 214 to achieve desired engine performance based on one or more engine conditions, for example, engine speed, engine load, engine temperature, boost, and/or manifold intake temperature. The variable intake valve closing mechanism 238 may also allow more precise control of the air/fuel ratio. By delaying closing of the intake valve assembly 214, the controller 244 may control the cylinder pressure during the compression stroke of the piston 212. For example, late closing of the intake valve reduces the compression work that the piston 212 must perform without compromising cylinder pressure and while maintaining a standard expansion ratio and a suitable air/fuel ratio.

The high pressure air provided by the air supply systems 100, 300, 400 may provide extra boost on the induction stroke of the piston 212. The high pressure may also enable the intake valve assembly 214 to be closed even later than in a conventional Miller cycle engine. In the present description, the intake valve assembly 214 may remain open until the second half of the compression stroke of the piston 212, for example, as late as about 80° to 70° before top dead center (“BTDC”). While the intake valve assembly 214 is open, air may flow between the chamber 206 and the intake manifold 114. Thus, the cylinder 112 experiences less of a temperature rise in the chamber 206 during the compression stroke of the piston 212.

Since the closing of the intake valve assembly 214 may be delayed, the timing of the fuel supply system may also be retarded. For example, the controller 244 may controllably operate the fuel injector assembly 240 to supply fuel to the combustion chamber 206 after the intake valve assembly 214 is closed. For example, the fuel injector assembly 240 may be controlled to supply a pilot injection of fuel contemporaneous with or slightly after the intake valve assembly 214 is closed and to supply a main injection of fuel contemporaneous with or slightly before combustion temperature is reached in the chamber 206. As a result, a significant amount of exhaust energy may be available for recirculation by the air supply system 100, 300, 400, which may efficiently extract additional work from the exhaust energy.

Referring to the air supply system 100 of FIG. 1, the second turbocharger 140 may extract otherwise wasted energy from the exhaust stream of the first turbocharger 120 to turn the compressor wheel 150 of the second turbocharger 140, which is in series with the compressor wheel 134 of the first turbocharger 120. The extra restriction in the exhaust path resulting from the addition of the second turbocharger 140 may raise the back pressure on the piston 212. However, the energy recovery accomplished through the second turbocharger 140 may offset the work consumed by the higher back pressure. For example, the additional pressure achieved by the series turbochargers 120, 140 may do work on the piston 212 during the induction stroke of the combustion cycle. Further, the added pressure on the cylinder resulting from the second turbocharger 140 may be controlled and/or relieved by using the late intake valve closing. Thus, the series turbochargers 120, 140 may provide fuel efficiency via the air supply system 100, and not simply more power

It should be appreciated that the air cooler 156, 356, 456 preceding the intake manifold 114 may extract heat from the air to lower the inlet manifold temperature, while maintaining the denseness of the pressurized air. The optional additional air cooler between compressors or after the air cooler 156, 356, 456 may further reduce the inlet manifold temperature, but may lower the work potential of the pressurized air. The lower inlet manifold temperature may reduce the NOₓ emissions.

Referring again to FIG. 7, a change in pressure of exhaust gases passing through the PM filter 806 results from an accumulation of particulate matter, thus indicating a need to regenerate the PM filter 806, i.e., burn away the accumulation of particulate matter. For example, as particulate matter accumulates, pressure in the PM filter 806 increases.

The PM filter 806 may be a catalyzed diesel particulate filter (“CDPF”) or an active diesel particulate filter (“ADPF”). A CDPF allows soot to burn at much lower temperatures. An ADPF is defined by raising the PM filter internal energy by means other than the engine 110, for example electrical heating, burner, fuel injection, and the like.

One method to increase the exhaust temperature and initiate PM filter regeneration is to use the throttle valve 814 to restrict the inlet air, thus increasing exhaust temperature. Other methods to increase exhaust temperature include variable geometry turbochargers, smart wastegates, variable valve actuation, and the like. Yet another method to increase exhaust temperature and initiate PM filter regeneration includes the use of a post injection of fuel, i.e., a fuel injection timed after delivery of a main injection.

The throttle valve 814 may be coupled to the EGR valve 812 so that they are both actuated together. Alternatively, the throttle valve 814 and the EGR valve 812 may be actuated independently of each other. Both valves may operate together or independently to modulate the rate of EGR being delivered to the intake manifold 114.

CDPFs regenerate more effectively when the ratio of NOₓ to particulate matter, i.e., soot, is within a certain range, for example, from about 20 to 1 to about 30 to 1. It has been found, however, that an EGR system combined with the above described methods of multiple fuel injections and variable valve timing results in a NOₓ to soot ratio of about 10 to 1. Thus, it may be desirable to periodically adjust the levels of emissions to change the NOₓ to soot ratio to a more desired range and then initiate regeneration. Examples of methods that may be used include adjusting the EGR rate and adjusting the timing of main fuel injection.

A venturi (not shown) may be used at the EGR entrance to the fresh air inlet. The venturi would depress the pressure of the fresh air at the inlet, thus allowing EGR to flow from the exhaust to the intake side. The venturi may include a diffuser portion that would restore the fresh air to near original velocity and pressure prior to entry into compressor 144. The use of a venturi and diffuser may increase engine efficiency.

An air and fuel supply system for an internal combustion engine in accordance with the embodiments may extract additional work from the engine's exhaust. The system may also achieve fuel efficiency and reduced NOₓ emissions, while maintaining work potential and ensuring that the system reliability meets with operator expectations.

Referring to FIGS. 8-13, high-pressure fuel enters the fuel injector 240 through high-pressure fuel supply line 630. It travels to control valve 632 where in the non-energized state, the flow is blocked. At this condition, the injector 240 is in a non-injection mode. High-pressure fuel supply line 630 is blocked and check line 644 is connected through control valve 632 to check control cavity line 658 and low-pressure drain line 660. It should be noted at this condition, both check line 644, fuel cavity 646, check control cavity line 658, and check control cavity 652 are all fluidly connected to low-pressure drain line 660 and subsequently to reservoir 610. When injection is desired, control valve 632 is actuated. Specifically, solenoid 256 is energized, thereby pulling up armature 636. As armature 636 pulls up, valve member 638 is pulled off of the lower seat 642. Those skilled in the art will recognize that the control valve could be equipped with a piezo-stack type actuator. As soon as the valve member 638 is pulled off the lower seat 642, high-pressure fuel from fuel supply line 630 is in fluid connection with check line 644 and check control cavity line 658 and low-pressure drain line 660. An orifice in low-pressure drain line 660 causes the flow to “back up” and move down check control cavity line 658 pressurizing check control cavity 652. At this stage, pressurized fuel exists in both fuel cavity 646 and check control cavity 652 and therefore the sum of the pressure and spring forces biases check valve 648 in the closed position.

By keeping pressurized fuel in the check control cavity 652 while valve member 638 is between the seats, injection is prevented during this transitional phase. This provides better control of the fuel delivery curve (See FIG. 13). Typical common rail fuel injectors 240 experience a decrease in fuel delivery as the valve member 638 hits the upper seat 640. Typically, the valve member 638 can bounce off the upper seat 640 for particular on-times (“T”) causing a reduction in fuel delivery and making injection predictability difficult, see standard fuel delivery curve 666. Ultimately, a specified range of the fuel delivery curve is deemed unusable, due to the lack of controllability, thereby eliminating efficiency of the injector. In the present case, the fuel injection does not occur until valve member 638 seats against the upper seat 640 due to the high-pressure flow entering check control cavity line 652 while the valve member is in transition, which provides a smoother second delivery curve 668. Once valve member 638 reaches the upper seat, pressurized fuel from high-pressure fuel supply line 630 is fluidly connected only to check line 644. Further, check control cavity 652 is allowed to drain to low-pressure drain line 660 thereby removing the pressure in check control cavity 652 and allowing fuel pressure in fuel cavity 646 to push check valve 648 up against check spring 650 and inject into the cylinder (not shown). It should be noted that orifice 662 provides a flow restriction in a low-pressure drain line 660. Low-pressure drain line 660 is always open to reservoir 610, therefore as soon as pressurized flow decreases enough that the flow can move through orifice 662, the pressure in check control cavity line 658 and check control cavity 652, can drain to low-pressure.

Once it is desirable to stop injection, control valve 632 is de-energized allowing armature 636 back down to its original position thereby moving valve member 638 from the upper seat 640 back down the lower seat 642. Once again during transition high-pressure fuel from fuel supply line 630 is fluidly connected to both the check line 644 and the check control cavity line 658 thereby providing a pressurized force in the check control cavity 652 to help close check valve 648. Furthermore, once valve member 638 reaches the lower seat 642 any remaining pressurized fuel in fuel cavity 646 and check line 644 is vented to the check control cavity line 658 thereby providing any residual pressure still existing in fuel cavity 646 to check control cavity 652 to help ensure quick closing of check 648. Finally pressure decreases in fuel cavity 646, check line 644, check control cavity 652 and check control cavity line 658 through orifice 662 to low-pressure through low-pressure drain line 660.

A second orifice 664 can be placed in the check control cavity line 658 to better control flow of pressurized fluid into check control cavity 652. As stated previously, second orifice 664 must be sized appropriately compared to orifice 662 in order to ensure that flow enters check control cavity 652 as opposed to going directly to reservoir 610 through low-pressure drain line 660.

The fuel injectors 240 shown in FIG. 10 and FIG. 11 function in a similar manner to that described above, except that check control cavity 652 is allowed to drain through low-pressure drain line segment A 661a and low-pressure drain line segment B 661b, thereby removing the pressure in check control cavity 652 and allowing fuel pressure in fuel cavity 646 to push check valve 648 up against check spring 650 and inject fuel into the cylinder (not shown). Orifice 662 provides a flow restriction in low-pressure drain line segments 661a and 661b. Low-pressure drain line 660 is always open to reservoir 610, therefore as soon as pressurized flow decreases enough that the flow can move through orifice 662, the pressure in check control cavity line 658 and check control cavity 652, can drain to low-pressure. When stopping injection, after valve member 638 returns to the lower seat 642, any pressure remaining in fuel cavity 646, check line 644, check control cavity 652 and check control cavity line 658 exits through orifice 662 through low-pressure drain line segment A 661a and low-pressure drain line segment B 661b.

It will be apparent to those skilled in the art that various modifications and variations can be made in the disclosed air and fuel supply system for an internal combustion engine without departing from the scope or spirit of the description. Other embodiments will be apparent to those skilled in the art from consideration of the specification and practice disclosed herein. It is intended that the specification and examples be considered as exemplary only.

1. A method of operating an internal combustion engine including at least one cylinder and a piston slidable in the cylinder, the method comprising:
supplying a mixture of pressurized air and recirculated exhaust gas from an intake manifold to an air intake port of a combustion chamber in the cylinder;
operating an air intake valve to open the air intake port to allow the pressurized air and exhaust gas mixture to flow between the combustion chamber and the intake manifold during a portion of a compression stroke of the piston; and
operably controlling a fuel supply system to inject fuel into the combustion chamber via a common rail fuel injector.

2. The method of claim 1, wherein the operating includes operating a variable intake valve closing mechanism to keep the intake valve open.

3. The method of claim 1, further comprising pressurizing a fuel rail with a high-pressure pump.

4. The method of claim 1, further comprising energizing a fuel injector solenoid to inject fuel.

5. The method of claim 1, further comprising cooling the mixture of pressurized air and recirculated exhaust gas before the mixture enters the main combustion chamber.

6. The method of claim 1, wherein operably controlling a fuel supply system to inject fuel comprises a pilot injection event before a main injection event.

7. The method of claim 6, wherein the main injection event occurs substantially during the compression stroke.

8. The method of claim 1, wherein supplying a mixture of pressurized air and recirculated exhaust gas includes providing a quantity of exhaust gas from an exhaust gas recirculation (“EGR”) system.

9. The method of claim 8, wherein providing a quantity of exhaust gas includes providing exhaust gas from a low pressure loop EGR system.

10. A variable compression ratio internal combustion engine, comprising:
an engine block defining at least one cylinder;
a head connected with the engine block, including an air intake port, and an exhaust port;
a piston slidable in each cylinder;
a combustion chamber being defined by the head, the piston, and the cylinder;
an air intake valve movable to open and close the air intake port;
an air supply system including at least one turbocharger fluidly connected to the air intake port;
an exhaust gas recirculation (“EGR”) system operable to provide a portion of exhaust gas from the exhaust port to the air supply system;
a common rail fuel supply system operable to inject fuel into the combustion chamber at a selected timing; and
a variable intake valve closing mechanism configured to keep the intake valve open by operation of the variable intake valve closing mechanism.

11. The engine of claim 10, further including a controller configured to operate the intake valve to remain open for a portion of a compression stroke.

12. The engine of claim 10, wherein the EGR system is a low pressure loop EGR system.

13. A method of controlling an internal combustion engine having a variable compression ratio, the engine having a block defining a cylinder, a piston slidable in the cylinder, a head connected with the block, the piston, the cylinder, and the head defining a combustion chamber, the method comprising:
pressurizing air;
supplying the air to an intake manifold of the engine;
maintaining fluid communication between the combustion chamber and the intake manifold during a portion of an intake stroke and through a portion of a compression stroke;
pressurizing a common rail fuel system with a high-pressure fuel pump; and
supplying pressurized fuel into the combustion chamber.

14. The method of claim 13, further comprising injecting fuel during a portion of the compression stroke.

15. The method of claim 13, wherein supplying pressurized fuel includes supplying a pilot injection before a main injection.

16. The method of claim 15, wherein the main injection begins during the compression stroke.

17. The method of claim 13, wherein maintaining fluid communication between the combustion chamber and the intake manifold occurs during a majority portion of the compression stroke.

18. The method of claim 13, further comprising cooling the pressurized air and exhaust gas mixture.

19. A method of operating an internal combustion engine including at least one cylinder and a piston slidable in the cylinder, the method comprising:
supplying pressurized air from an intake manifold to an air intake port of a combustion chamber in the cylinder;
operating an air intake valve to open the air intake port to allow the pressurized air to flow between the combustion chamber and the intake manifold during a portion of a compression stroke of the piston; and
injecting fuel into the combustion chamber via a common rail fuel injector.

20. The method of claim 19, wherein operating an air intake valve includes operating a variable intake valve closing mechanism to keep the intake valve open.

21. The method of claim 19, further comprising pressurizing a fuel rail with a high-pressure pump.

22. The method of claim 19, further comprising energizing a fuel injector's solenoid to inject fuel.

23. The method of claim 19, further comprising cooling the pressurized air before the mixture enters the main combustion chamber.

24. The method of claim 19, wherein operably controlling a fuel supply system to inject fuel comprises a pilot injection event before a main injection event.

25. The method of claim 19, wherein the main injection event occurs substantially during the compression stroke.
